(19) United States
(12) Patent Application Publication
(10) Pub. No.: US 2026/0283764 A1
(43) Pub. Date: Sep. 24, 2026

(54) DENTAL SURVEYOR AND SURVEY METHOD

(71) Applicant: Jui-Yuan Shih, Lukang Township (TW)

(72) Inventor: Jui-Yuan Shih, Lukang Township (TW)

(21) Appl. No.: 19/083,175

(22) Filed: Mar. 18, 2025

(30) Foreign Application Priority Data
Mar. 24, 2024 (TW) 113110572

(51) Int. Cl. A61C 13/00

(52) U.S. Cl. CPC A61C 13/0027

(57) ABSTRACT

A dental surveyor includes a surveyor and a surveyor table. The surveyor includes a surveyor platform, vertical column, first surveying arm, second surveying arm, and vertical spindle. The vertical column, first surveying arm, and second surveying arm rotate pivotally relative to each other. The second surveying arm has a vertical spindle fitted with an analyzing rod for surveying a cast. The surveyor table includes a cast clamping table and a surveyor table base. The surveyor table is placed on the surveyor platform. The cast clamping table is configured to grip the cast. The surveyor table base facilitates changes in the angle and direction of the cast clamping table. Three base adjustment screws are secured to the surveyor table base and configured to advances and retreats to change the corresponding height of the cast clamping table, achieving cast tripoding and precise cast orientation adjustment.

### FIELD

The present disclosure relates to dental surveyors and survey methods, and more particularly to a dental surveyor whereby users carry out surveys and corrections quickly and a survey method of determining, recording and reproducing the path of insertion and removal of a cast on a dental surveyor.

### BACKGROUND

Every person has only one set of permanent teeth in a lifetime. Once damaged, they cannot be replaced. With the increase in average life expectancy, greater importance should be placed on dental health care. Dental abnormalities and diseases are complex, with caries and periodontal disease being the most common. Furthermore, teeth may be removed under external forces before aging. Gaps left by missing teeth can affect surrounding healthy teeth. The surrounding teeth may gradually become loose and detached because of the lack of support from adjacent teeth, causing a vicious cycle to all teeth. Therefore, the gaps must be filled timely with partial dentures. Conventional partial dentures include expensive dental implants, fixed dental bridges, dental crowns, and removable partial dentures. Differences in tooth shape, mouth shape, and gum condition among patients necessitate the creation of their casts to facilitate subsequent fabrication of partial dentures, dental bridges, dental crowns, and removable partial dentures.

Partial denture fabrication requires coordination and cooperation between the dentist and the dental technician. Dental bridges, dental crowns, and removable partial dentures all require an insertion direction (path of insertion and removal); thus, in case of an angular or directional error, none of the dental bridges, dental crowns, and removable partial dentures can be successfully installed. When the dentist and the dental technician work together, they need to confirm the accuracy of the cast's angle and direction. Therefore, a surveyor is needed to carry out height confirmation and ensure that the locating dots on the cast are aligned. Furthermore, the surveyor is capable of adjustment and thus enables the dental technician to attain the same cast direction as designed and instructed by the dentist, preventing installation angle-related issues which might otherwise occur to a subsequent process of processing the partial dentures, dental bridges, dental crowns, and removable partial dentures.

It is necessary to speed up the survey locating process and, under the premise of acceptable precision and margin of error, use the surveyor to survey the locating dots on the cast, with a view to ensuring consistency in the angle and direction of the cast for both the dentist and the dental technician, reducing preparatory work, reducing a waste of time, and optimizing the dental technician's processing work and the dentist's design work.

Referring to FIG. 26, a surveyor table (91) of a conventional dental surveyor (90) has only one ball joint (92). The course of determining, recording and reproducing the path of insertion and removal of a cast on the conventional dental surveyor (90) is at a disadvantage due to a drawback: an established direction alters as a result of the motion of the ball joint (92) while another direction is being determined. The relationship between two dots adjusted to be of equal height alters as a result of the motion of the ball joint (92) while the height of the other dot is being adjusted during a tripoding process performed on the conventional dental surveyor (90). As a result, determining, recording and reproducing the path of insertion and removal of a cast on the conventional dental surveyor (90) is difficult, and partial denture fabrication is imprecise to the detriment of the use of partial dentures by patients.

In view of this, the inventor of the disclosure came up with an idea for an invention. To this end, the inventor undertook a design process based on years of experience, conducted extensive discussions, built prototypes to be tested, and made amendments and improvements, culminating in the realization of the invention.

### SUMMARY

### The Technical Issue to Address

The technical issue to be addressed by the disclosure is related to overcoming the aforesaid drawbacks of the prior art by providing a dental surveyor and a survey method of using the dental surveyor to allow users to carry out surveys and corrections quickly.

### Problem-Solving Technical Features

The disclosure provides a dental surveyor comprising a surveyor and a surveyor table. The surveyor comprises a surveyor platform, a vertical column, a first surveying arm, a second surveying arm, and a vertical spindle. The vertical column is secured to the surveyor platform. The first surveying arm is pivotally connected to the vertical column, and the second surveying arm is pivotally connected to the first surveying arm, causing the vertical column, first surveying arm, and second surveying arm to rotate pivotally relative to each other. The second surveying arm is fitted with the vertical spindle. The vertical spindle is fitted with an analyzing rod for surveying a cast. The surveyor table comprises a cast clamping table and a surveyor table base. The surveyor table is placed on the surveyor platform. The cast clamping table is configured to grip a cast and have a cast holding knob for adjusting grip tightness. A spherical swivel ball is disposed at the bottom of the cast clamping table. A clamping device is disposed centrally on the surveyor table base, fitted with a tilting adjustment knob, and configured to hold the swivel ball. The tilting adjustment knob is rotatable to release the clamping device to adjust the swivel ball and thus cause alteration of the angle and direction of the cast clamping table. A swivel ball housing is disposed at the top of the surveyor table base to restrain the swivel ball. The surveyor table base is fitted with a first base adjustment screw, a second base adjustment screw, and a third base adjustment screw. The locating dot height of the cast gripped and held on the cast clamping table, which corresponds to the height of the first base adjustment screw, the second base adjustment screw, or the third base adjustment screw, is changed because of advances and retreats of the first base adjustment screw, the second base adjustment screw, or the third base adjustment screw, achieving tripoding adjustment.

Furthermore, the vertical column is secured to the surveyor platform, and a pivot shaft is disposed at the top of the vertical column. The first surveying arm is penetrated by an axial hole and a first hinge hole. A first insertion hole and a second insertion hole are formed on lateral sides of the axial hole and the first hinge hole respectively. The pivot shaft of the vertical column is penetratingly disposed in the axial hole. The second surveying arm is penetrated by a second hinge hole and a vertical spindle hole. A third insertion hole and three fourth insertion holes are formed on lateral sides of the second hinge hole and the vertical spindle hole respectively. The vertical spindle hole is fitted with a vertical spindle bushing. The fourth insertion holes are fitted with spring-loaded ball screws to allow the vertical spindle bushing to be secured inside the fourth insertion holes. A vertical spindle is penetratingly disposed in the vertical spindle bushing. A stop portion is fitted to the top of the vertical spindle and configured to abut the vertical spindle bushing to limit a range of motion (ROM) of the vertical spindle. The spring-loaded ball screws are secured to upper and lower ones of the fourth insertion holes respectively. The spring-loaded ball screws exert uniform pressure on the vertical spindle to eliminate the tolerance of the vertical spindle inside the vertical spindle bushing to enhance precision. A vertical spindle fastening screw is secured to a middle one of the fourth insertion holes, configured to abut the vertical spindle, and configured to be tightened or loosened to adjust and then fix the position of the vertical spindle. A sliding bushing is penetratingly disposed in each of the first hinge hole and the second hinge hole and penetrated by a pivotal connection shaft. A stopping screw is screwed into the second insertion hole to abut the pivotal connection shaft to secure the pivotal connection shaft in place and thus cause the vertical column, the first surveying arm, and the second surveying arm to rotate pivotally relative to each other. The first surveying arm is secured to the first insertion hole and the pivot shaft by a clamping lever to adjust and then fix the angle between the vertical column and the first surveying arm. The second surveying arm is secured to the third insertion hole by another said clamping lever to abut the pivotal connection shaft to adjust and then fix the angle between the first surveying arm and the second surveying arm. Tops of the pivot shaft and the pivotal connection shaft are provided with a cover screw for restraining the tops. The first surveying arm and the second surveying arm have washers and bearing portions for enhancing smoothness of pivotal rotation to enable the vertical column, the first surveying arm, and the second surveying arm to rotate pivotally relative to each other interlockingly. The first surveying arm and the second surveying arm have washers and bearing portions for enhancing smoothness of pivotal rotation to enable the vertical column, the first surveying arm, the second surveying arm, and the vertical spindle to not only rotate pivotally relative to each other interlockingly but also maintain precise parallelism and perpendicularity.

The disclosure provides a survey method of using the dental surveyor to precisely determine the path of insertion and removal of the cast on the surveyor, the survey method comprising steps of: adjusting an angle and direction of the cast, by a dentist with the tilting adjustment knob, to preliminarily determine front-back and left-right inclinations of the cast and allow the first base adjustment screw, the second base adjustment screw, and the third base adjustment screw to be near the cast in front-back and left-right directions respectively; and determining and adjusting the first base adjustment screw, the second base adjustment screw, or the third base adjustment screw to adjust the front-back and left-right inclinations of the cast.

The disclosure provides a survey method of using the dental surveyor to record and reproduce the path of insertion and removal of the cast on the surveyor, the survey method comprising steps of: recording, by a dentist, the path of insertion and removal of the cast on the dental surveyor such that the determined direction and inclinations of the surveyed cast define the path of insertion and removal, and three separate points of equal elevation on the surface of the cast are selected according to a tripoding method to define a first locating dot, a second locating dot, and a third locating dot before the dentist sends the cast to a dental technician to proceed with reproduction of the path of insertion and removal of the cast and partial denture fabrication; and adjusting, by the dental technician and before the partial denture fabrication, a position and angle of the cast on the dental surveyor to allow the first locating dot, the second locating dot, and the third locating dot to be adjusted to attain equal height so as to reproduce the cast's insertion and removal path as determined by the dentist.

The disclosure provides a relocating method using the dental surveyor to locate the path of insertion and removal of the cast on the surveyor, the relocating method comprising steps of: selecting points of equal elevation on a surface of the cast to define a first locating dot a second locating dot and a third locating dot which form a triangle, rotating the tilting adjustment knob to release the clamping device to adjust the swivel ball and thus cause an angle and direction of the cast clamping table to change, and adjusting an angle and direction of the cast to allow the first locating dot, the second locating dot, and the third locating dot to be not only near the first base adjustment screw, the second base adjustment screw, and the third base adjustment screw respectively but also equal in height to complete preliminary calibration; and measuring the height of the second locating dot using a tip of the analyzing rod, with the second base adjustment screw as a reference, adjusting the first base adjustment screw to adjust the height of the first locating dot to allow the first locating dot and the second locating dot to be of equal height, confirming the height of the first locating dot and the second locating dot using the analyzing rod, adjusting the third base adjustment screw to adjust the height of the third locating dot to allow the first locating dot and the third locating dot to be of equal height, and adjusting the first base adjustment screw to adjust the height of the first locating dot to allow the first locating dot and the second locating dot to be of equal height, such that the first locating dot, the second locating dot, and the third locating dot become equal in height through repeated adjustments, allowing the cast to attain a correct angle and direction and thus achieve precise calibration.

The objective of the dental surveyor of the disclosure is to enable the angle and direction of the cast to be adjusted using the surveyor table base such that the first locating dot, the second locating dot, and the third locating dot are not only preliminarily near the first base adjustment screw, the second base adjustment screw, and the third base adjustment screw respectively but also nearly equal in height in order for preliminary calibration to be carried out quickly, to enable the height of a portion of the cast to be adjusted using the first base adjustment screw, the second base adjustment screw, and the third base adjustment screw in order for tripoding to be carried out quickly, intuitively, easily and precisely, and to enable the vertical column, the first surveying arm, and the second surveying arm to rotate pivotally relative to each other, and the analyzing rod to quickly measure the heights of the first locating dot, the second locating dot, and the third locating dot to carry out the survey method, achieving efficiency enhancement.

The objective of the survey method of the disclosure is to enable height errors to be reduced through iterative approximation performed between the third locating dot and the second locating dot after the first locating dot and the second locating dot have been adjusted to be of equal height such that the first locating dot, the second locating dot, and the third locating dot become equal in height sooner to allow the cast to attain the correct angle and direction to facilitate cooperation between the dentist and the dental technician, further enhancing operation efficiency.

Other objectives, advantages, and novel features of the disclosure are herein illustrated with embodiments, depicted with accompanying drawings, and described below.

### BRIEF DESCRIPTION OF THE DRAWINGS

FIG. 1 is a perspective view of a surveyor and a surveyor table of a dental surveyor of the disclosure.

FIG. 2 is an exploded view of the surveyor according to the disclosure.

FIG. 3 is an exploded view of the surveyor table according to the disclosure.

FIG. 4 is a cross-sectional view of the dental surveyor of the disclosure.

FIG. 5 is a schematic view of mounting an analyzing rod in place and gripping a cast according to the disclosure.

FIG. 6 is a schematic view of pivotally rotating the surveyor to survey the cast according to the disclosure.

FIG. 7 is a schematic view of adjusting the angle of a cast clamping table according to the disclosure.

FIG. 8 is a schematic view of using base adjustment screws to adjust the height of the cast clamping table according to the disclosure.

FIG. 9 is a schematic view of adjusting the positions of locating dots relative to the base adjustment screws, and vice versa, before a survey according to the disclosure.

FIG. 10 is a top view of adjusting the positions of the locating dots relative to the base adjustment screws, and vice versa, before a survey, showing that the locating dots are near the base adjustment screws respectively according to the disclosure.

FIG. 11 is a schematic view of the cast and the locating dots according to the disclosure.

FIG. 12 is a schematic view of displaying the locating dots via projection according to the disclosure.

FIG. 13 is a schematic view of surveying a first locating dot according to the disclosure.

FIG. 14 is a schematic view of surveying a second locating dot according to the disclosure.

FIG. 15 is a schematic view of displaying a first calibration via projection according to the disclosure.

FIG. 16 is a schematic view of surveying a third locating dot according to the disclosure.

FIG. 17 is a schematic view of adjusting a projection of a third base adjustment screw according to the disclosure.

FIG. 18 is a schematic view of displaying a second calibration via projection according to the disclosure.

FIG. 19 is a schematic view of displaying a third calibration via projection according to the disclosure.

FIG. 20 is a schematic view of adjusting a first base adjustment screw according to the disclosure.

FIG. 21 is a schematic view of adjusting a projection of the first base adjustment screw according to the disclosure.

FIG. 22 is a schematic view of displaying a fourth calibration via projection according to the disclosure.

FIG. 23 is an enlarged schematic view of displaying the fourth calibration via projection according to the disclosure.

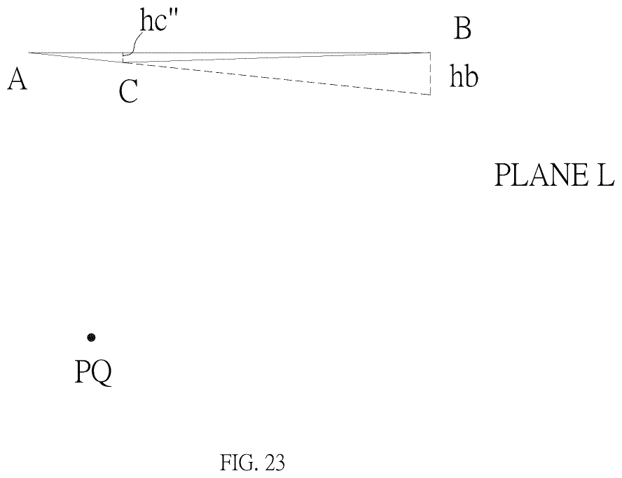

FIG. 24 is a schematic view of actually surveying the cast according to the disclosure.

FIG. 25 is another schematic view of actually surveying the cast according to the disclosure.

FIG. 26 (PRIOR ART) is a perspective view of a conventional dental surveyor.

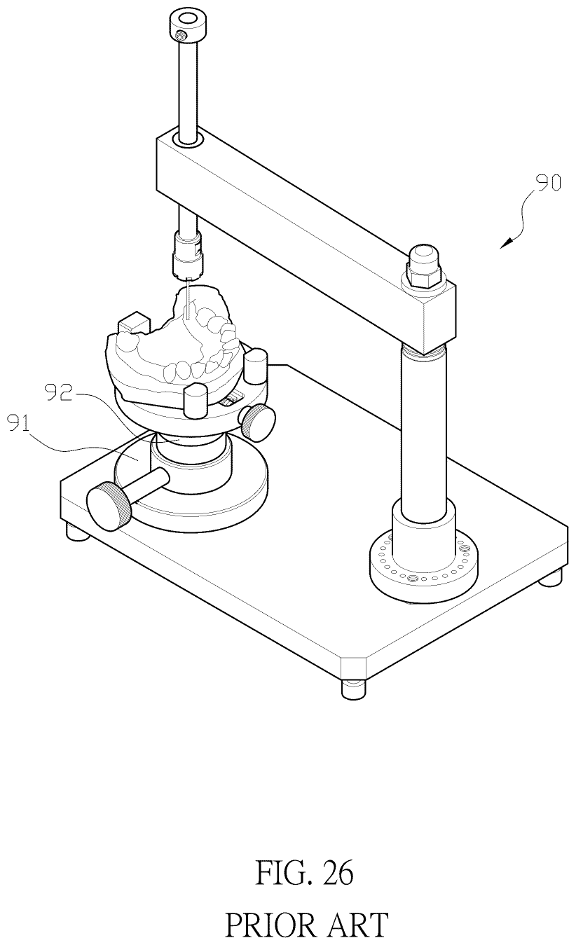

### DETAILED DESCRIPTION

Objectives, features, and advantages of the disclosure are herein illustrated with specific embodiments, depicted with drawings, and described below.

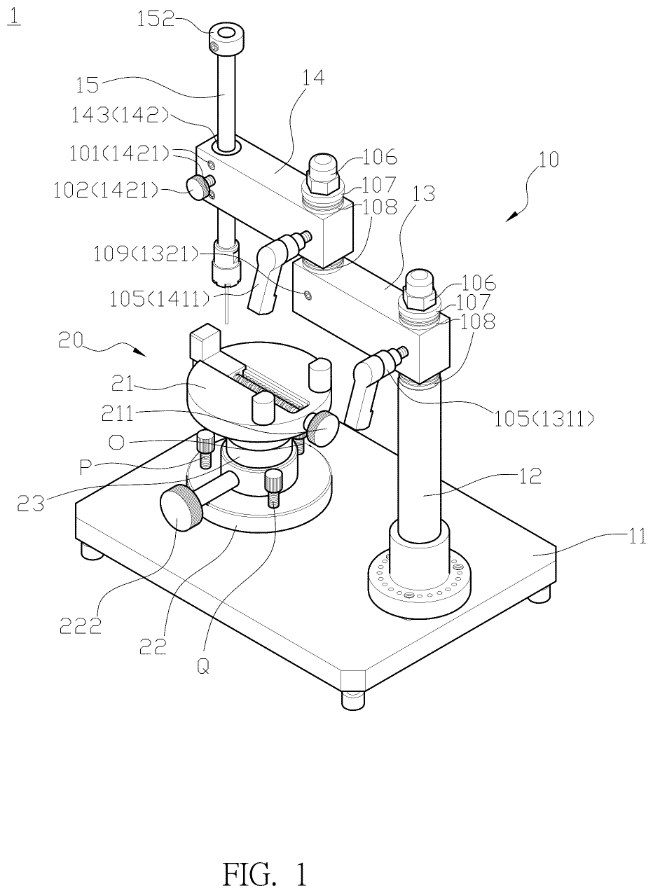

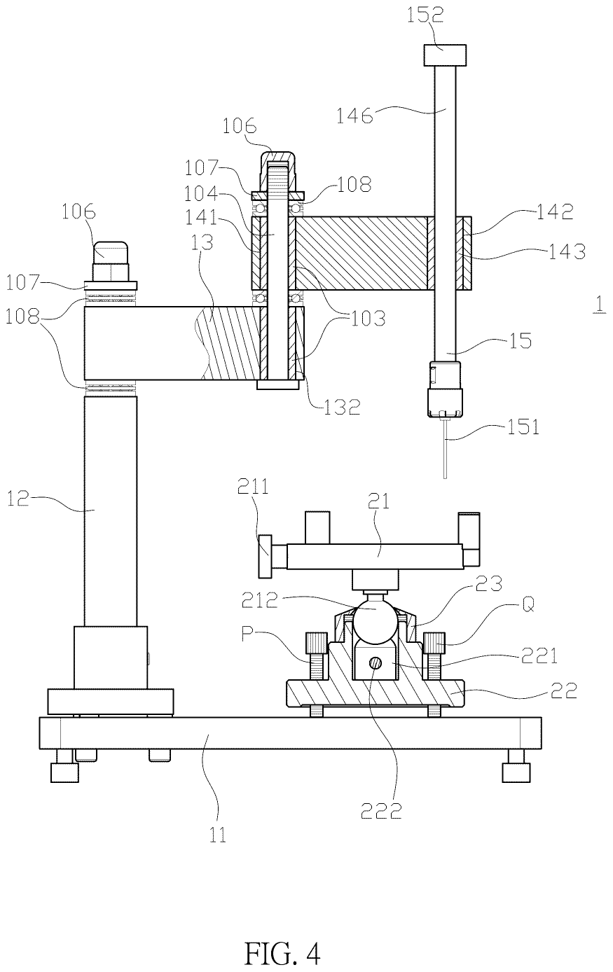

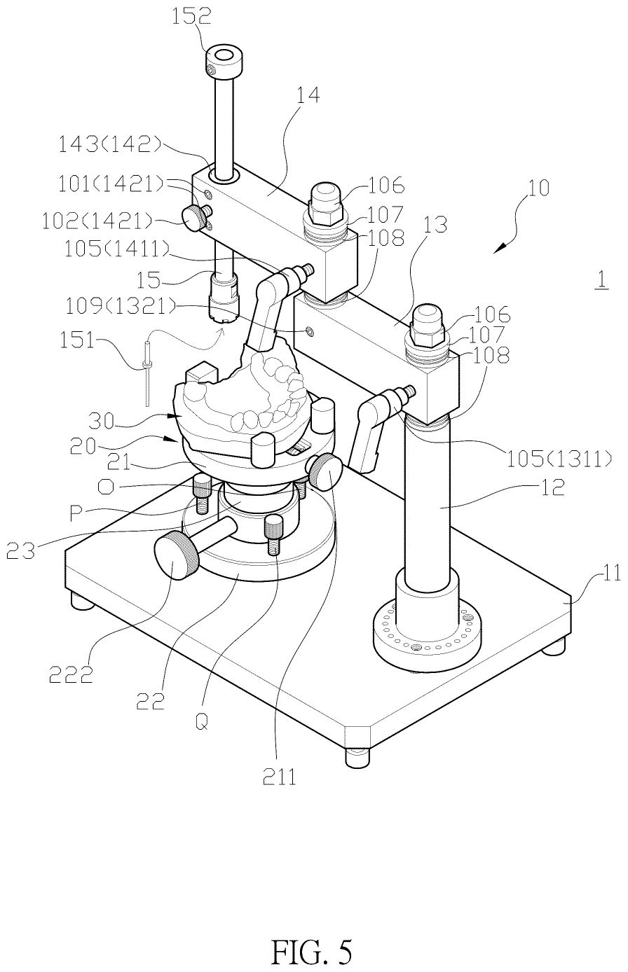

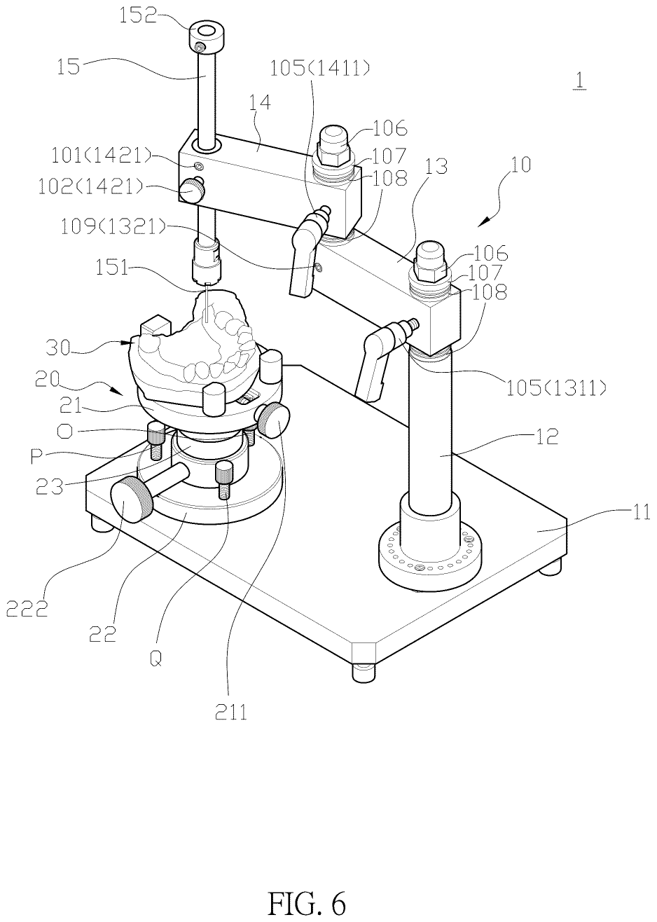

Referring to FIG. 1 through FIG. 6, the disclosure provides a dental surveyor (1) comprising a surveyor (10) and a surveyor table (20).

A concise aspect of the surveyor (10) of the disclosure is described below. The surveyor (10) comprises a surveyor platform (11), a vertical column (12), a first surveying arm (13), a second surveying arm (14), and a vertical spindle (15). The vertical column (12) is secured to the surveyor platform (11). The first surveying arm (13) is pivotally connected to the vertical column (12). The second surveying arm (14) is pivotally connected to the first surveying arm (13) to cause the vertical column (12), the first surveying arm (13), and the second surveying arm (14) to rotate pivotally relative to each other. The second surveying arm (14) is fitted with the vertical spindle (15). The vertical spindle (15) is fitted with an analyzing rod (151) for surveying a cast (30).

A complete aspect of the surveyor (10) of the disclosure is described below. The surveyor (10) comprises a surveyor platform (11), a vertical column (12), a first surveying arm (13), a second surveying arm (14), and a vertical spindle (15). The vertical column (12) is secured to the surveyor platform (11). A pivot shaft (121) is disposed at the top of the vertical column (12). The first surveying arm (13) is penetrated by an axial hole (131) and a first hinge hole (132). A first insertion hole (1311) and a second insertion hole (1321) are formed on lateral sides of the axial hole (131) and the first hinge hole (132) respectively. The pivot shaft (121) of the vertical column (12) is penetratingly disposed in the axial hole (131). The second surveying arm (14) is penetrated by a second hinge hole (141) and a vertical spindle hole (142). A third insertion hole (1411) and three fourth insertion holes (1421) are formed on lateral sides of the second hinge hole (141) and the vertical spindle hole (142) respectively. The vertical spindle hole (142) is fitted with a vertical spindle bushing (143). Spring-loaded ball screws (101) are secured to the fourth insertion holes (1421) to allow the vertical spindle bushing (143) to be secured inside the fourth insertion holes (1421). The vertical spindle (15) is penetratingly disposed in the vertical spindle bushing (143). The vertical spindle (15) is fitted with an analyzing rod (151) for surveying a cast (30). A stop portion (152), provided in the form of a stop ring, is secured to the top of the vertical spindle (15) and configured to abut the vertical spindle bushing (143) and thereby limit the range of motion (ROM) of the vertical spindle (15). The spring-loaded ball screws (101) are secured to upper and lower ones of the fourth insertion holes (1421) respectively. The spring-loaded ball screws (101) exert uniform pressure on the vertical spindle (15) to eliminate the tolerance of the vertical spindle (15) inside the vertical spindle bushing (143) and thereby enhance precision. A vertical spindle fastening screw (102) is secured to the middle one of the fourth insertion holes (1421) and configured to abut the vertical spindle (15). The vertical spindle fastening screw (102) is tightened or loosened to adjust and secure the vertical spindle (15) in place. A sliding bushing (103) is penetratingly disposed in the first hinge hole (132). Another sliding bushing (103) is penetratingly disposed in the second hinge hole (141). The two sliding bushings (103) are penetrated by a pivotal connection shaft (104). A stopping screw (109) is screwed into the second insertion hole (1321) to abut the pivotal connection shaft (104) and thereby secure the pivotal connection shaft (104) in place and thus cause the vertical column (12), the first surveying arm (13), and the second surveying arm (14) to rotate pivotally relative to each other. The first surveying arm (13) is secured to the first insertion hole (1311) and the pivot shaft (121) by a clamping lever (105) to adjust and then fix the angle between the vertical column (12) and the first surveying arm (13). The second surveying arm (14) is secured to the third insertion hole (1411) by another said clamping lever (105) to abut the pivotal connection shaft (104) to adjust and then fix the angle between the first surveying arm (13) and the second surveying arm (14). Tops of the pivot shaft (121) and the pivotal connection shaft (104) are provided with a cover screw (106) for restraining the tops. The first surveying arm (13) and the second surveying arm (14) have washers (107) and bearing portions (108) for enhancing the smoothness of pivotal rotation. The washers (107) protect the bearing portions (108) below to enable the vertical column (12), the first surveying arm (13), and the second surveying arm (14) to rotate pivotally relative to each other interlockingly.

The surveyor table (20) comprises a cast clamping table (21) and a surveyor table base (22). The surveyor table (20) is placed on the surveyor platform (11). The cast clamping table (21) is configured to grip a cast (30) and have a cast holding knob (211) for adjusting grip tightness. A spherical swivel ball (212) is disposed at the bottom of the cast clamping table (21). A clamping device (221) is disposed centrally on the surveyor table base (22), fitted with a tilting adjustment knob (222), and configured to hold the swivel ball (212). The tilting adjustment knob (222) is rotatable to release the clamping device (221) to adjust the swivel ball (212) and thus cause alteration of the angle and direction of the cast clamping table (21). A swivel ball housing (23) is disposed at the top of the surveyor table base (22) to restrain the swivel ball (212). The surveyor table base (22) is fitted with a first base adjustment screw (O), a second base adjustment screw (P), and a third base adjustment screw (Q). Advances and retreats of the first base adjustment screw (O), the second base adjustment screw (P), or the third base adjustment screw (Q) cause points of equal elevation of the cast (30) on the cast clamping table (21), which correspond to the first base adjustment screw (O), the second base adjustment screw (P), or the third base adjustment screw (Q), as well as the height of the first locating dot, the height of the second locating dot, or the height of the third locating dot to alter, locating three dots (tripods).

The disclosure provides a dental surveyor (1) characterized in that the vertical spindle bushing (143) is made of copper and provided in the form of a centrally-bored copper post.

The disclosure provides a dental surveyor (1) characterized in that the bearing portions (108) are thrust bearings that exhibit satisfactory parallelism and precision during pivotal rotation.

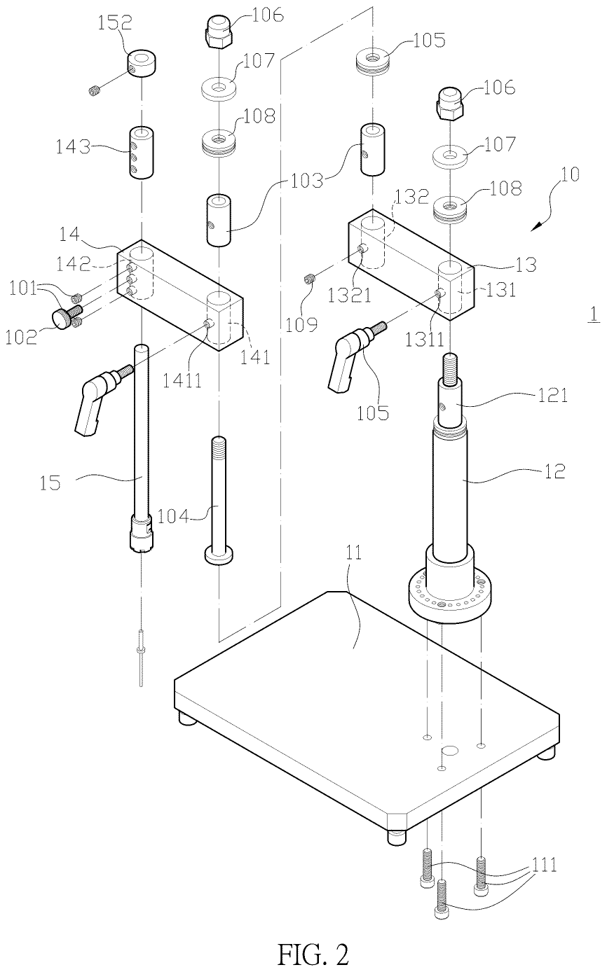

Referring to FIG. 2, the disclosure provides a dental surveyor (1) characterized in that the vertical column (12) is secured to the surveyor platform (11) from bottom to top using screw fasteners (111).

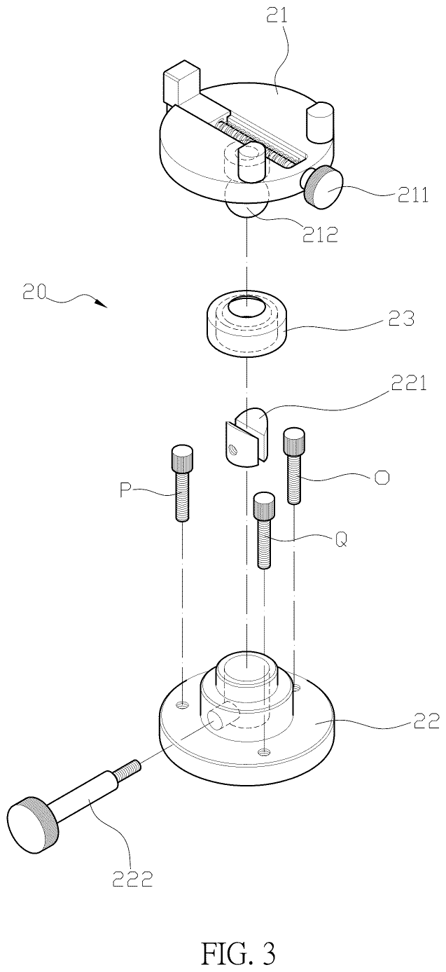

Referring to FIG. 3, the disclosure provides a dental surveyor (1) characterized in that the first base adjustment screw (O), the second base adjustment screw (P), and the third base adjustment screw (Q) are evenly and annularly disposed on the surveyor table base (22).

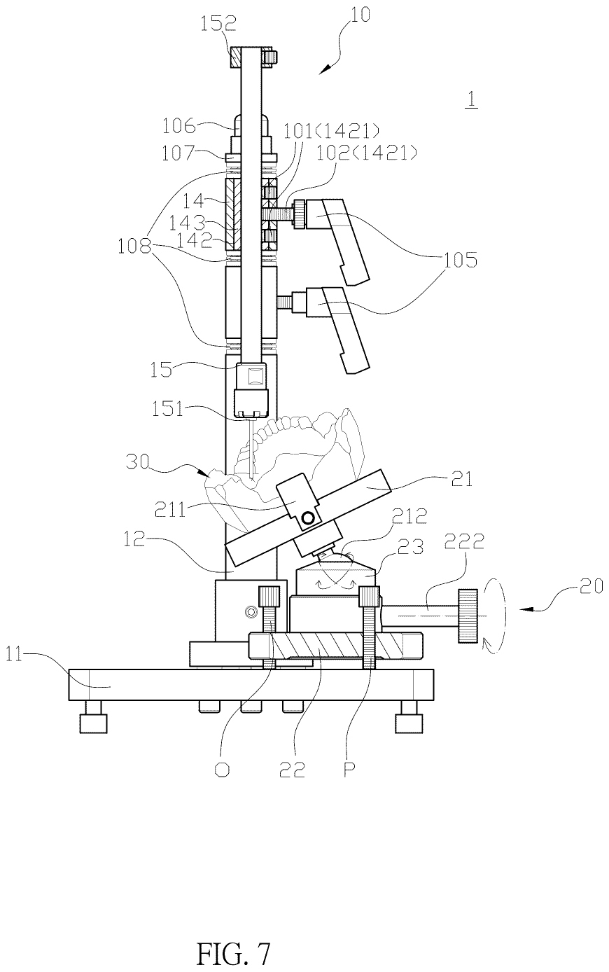

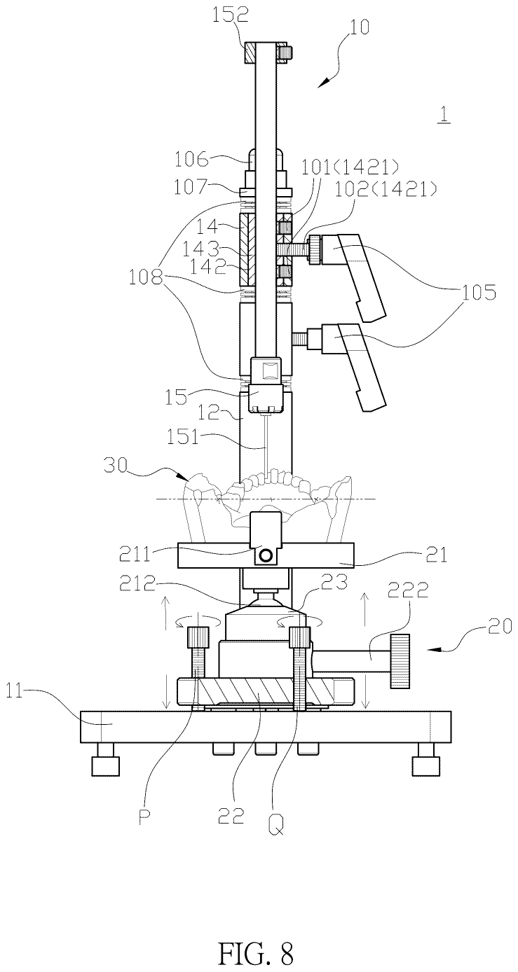

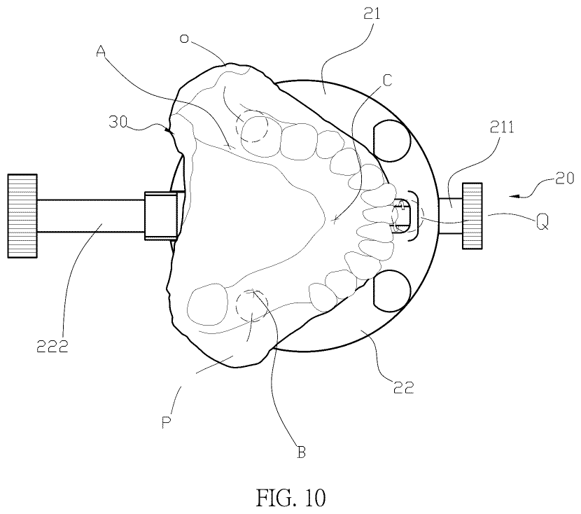

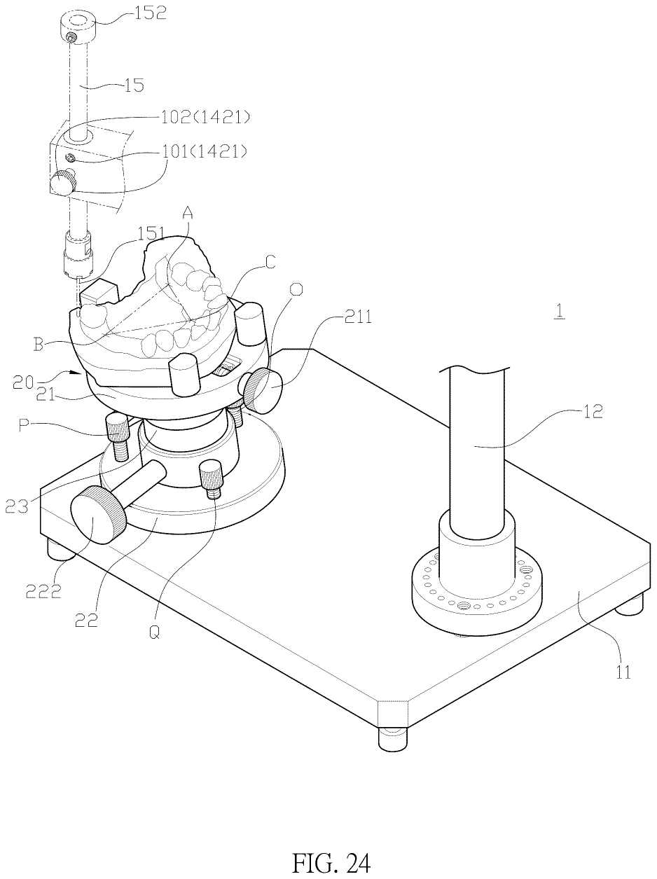

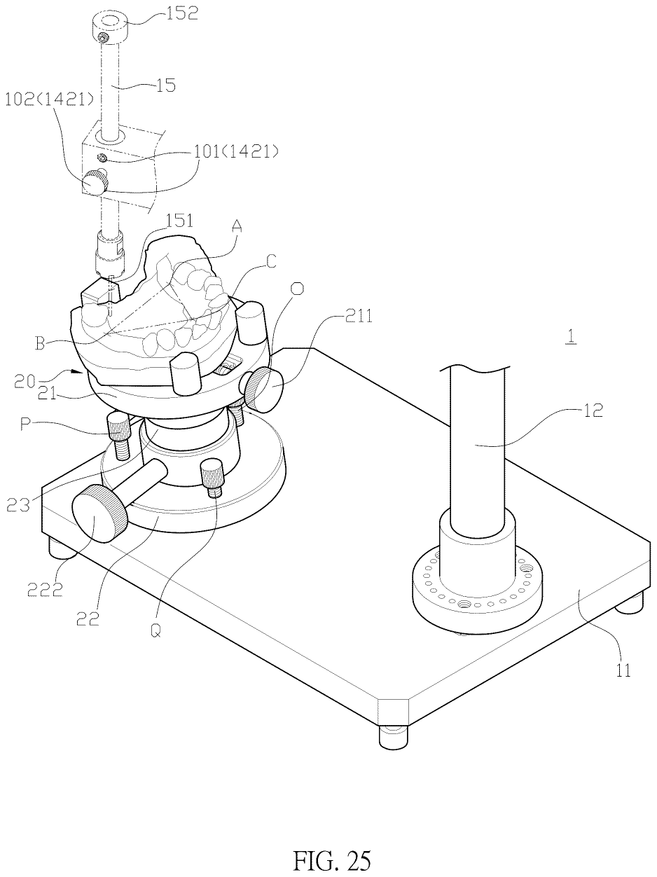

Referring to FIG. 7, the disclosure provides a survey method of using the dental surveyor (1) to precisely determine the path of insertion and removal of the cast on the surveyor. The steps of the survey method are described below. A dentist adjusts the angle and direction of the cast (30) with the tilting adjustment knob (222) to preliminarily determine the front-back and left-right inclinations of the cast (30). Referring to FIG. 10, the first base adjustment screw, the second base adjustment screw, and the third base adjustment screw are near the cast (30) in front-back and left-right directions respectively. Referring to FIG. 8, since adjusting any one of the first base adjustment screw (O), the second base adjustment screw (P), and the third base adjustment screw (Q) does not affect the other two, the front-back and left-right inclinations of the cast (30) can be precisely adjusted and determined using the first base adjustment screw (O), the second base adjustment screw (P), or the third base adjustment screw (Q). Therefore, adjusting the first base adjustment screw, the second base adjustment screw, or the third base adjustment screw is conducive to precisely adjusting the front-back and left-right directions of the cast (30). Referring to FIGS. 24 and 25, the analyzing rod (151) is used to survey a tooth portion of the cast (30) to provide reference for determining a path of insertion during partial denture fabrication, precisely adjust and determine the path of insertion and removal of the cast (30), and thus enable the fabricated partial denture to be worn at its optimal angle. Therefore, the path of insertion and removal of the cast (30) on a dental surveyor can be precisely determined.

Referring to FIG. 7 through FIG. 11, the disclosure provides a survey method for recording and reproducing the path of insertion and removal of the cast (30) on a dental surveyor (1). The survey method comprises steps as follows: (I) recording, by a dentist, the path of insertion and removal of the cast (30) on the dental surveyor such that the determined direction and inclinations of the surveyed cast (30) define the path of insertion and removal, and three separate points of equal elevation on the surface of the cast (30) are selected according to a tripoding method to define a first locating dot (A), a second locating dot (B), and a third locating dot (C) before the dentist sends the cast (30) to a dental technician to proceed with reproduction of the path of insertion and removal of the cast (30) and partial denture fabrication; and (II) adjusting, by the dental technician and before the partial denture fabrication, the position and angle of the cast (30) on the dental surveyor (1) to allow the first locating dot (A), the second locating dot (B), and the third locating dot (C) to be adjusted to attain equal height so as to reproduce the cast's insertion and removal path as determined by the dentist.

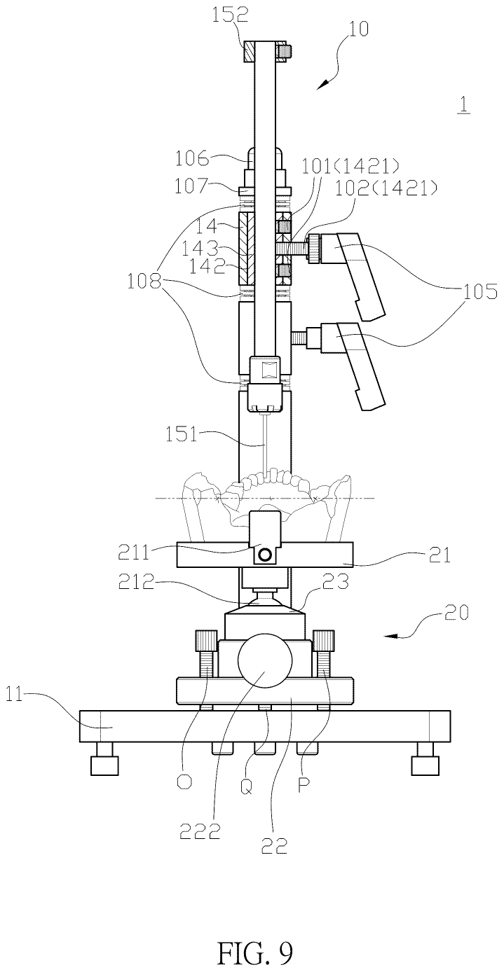

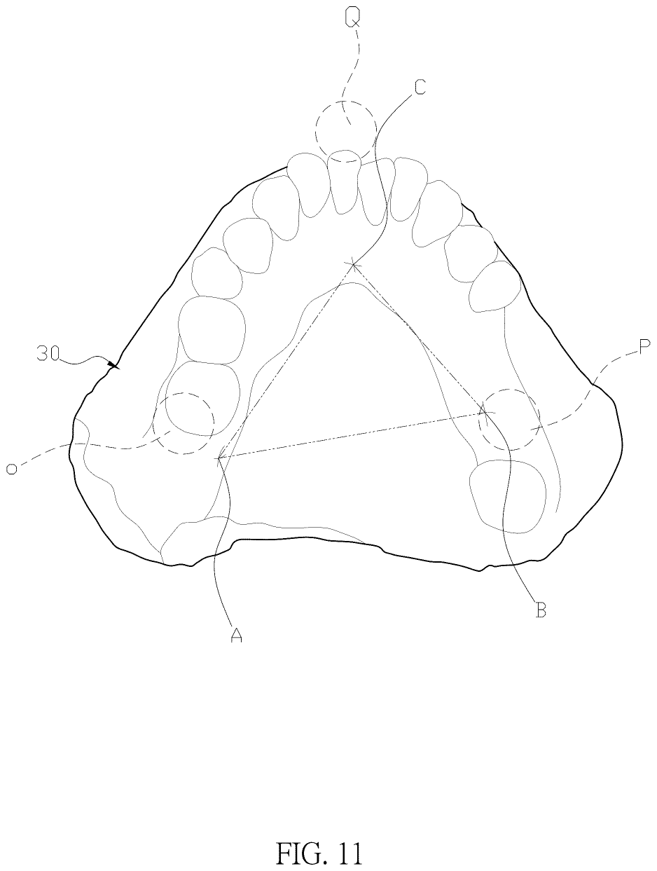

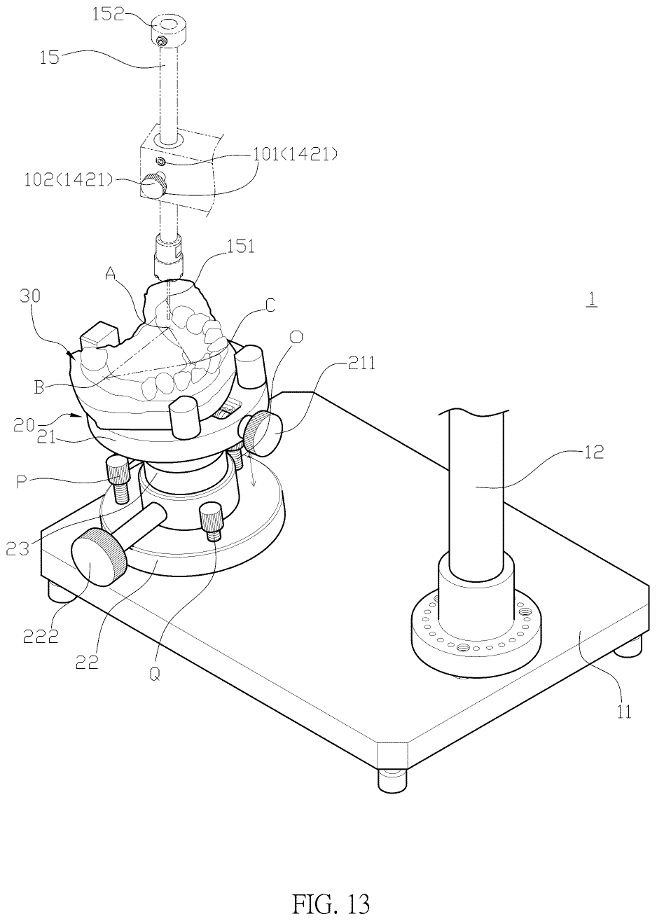

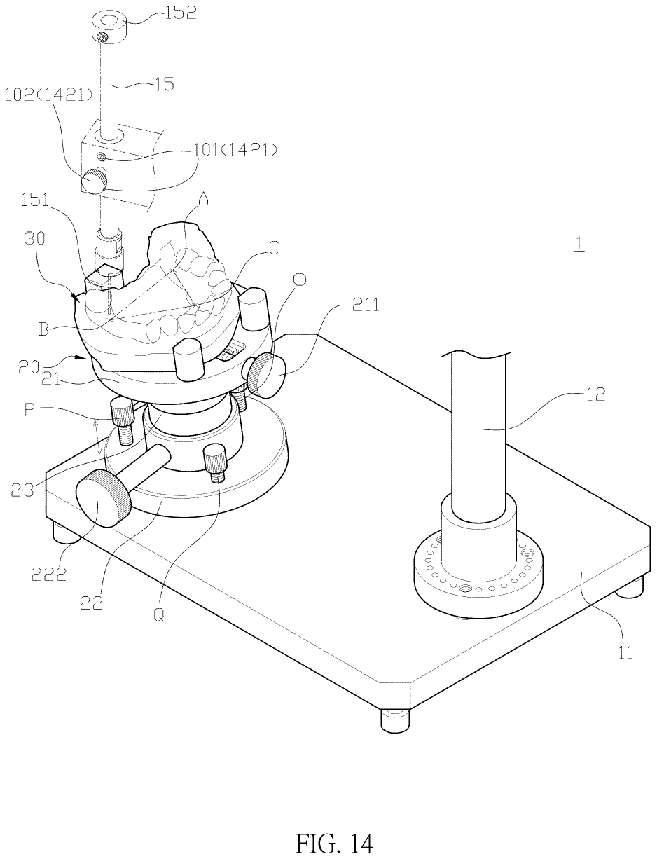

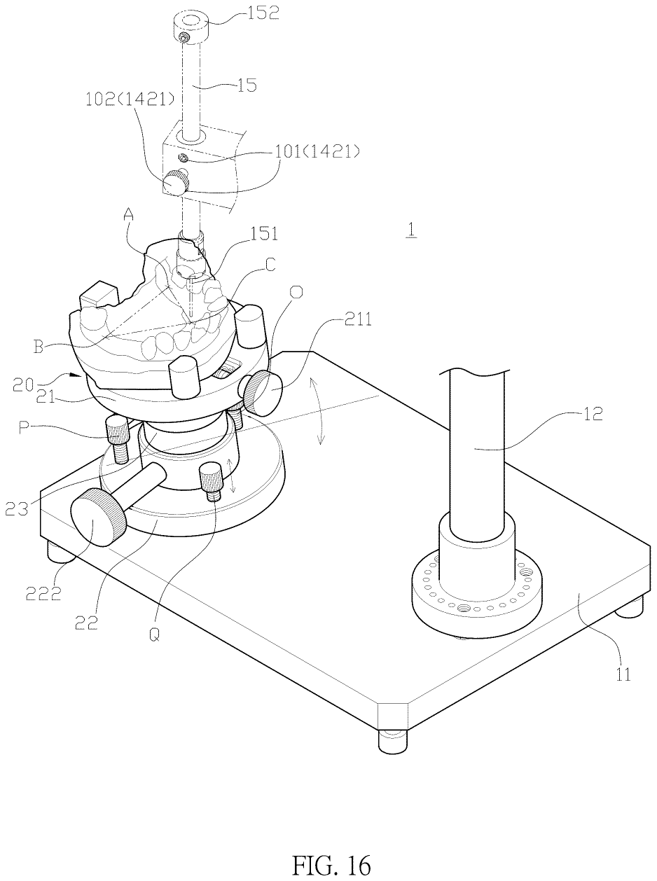

Referring to FIG. 11, the disclosure provides a relocating method using the dental surveyor (1) to locate the path of insertion and removal of the cast on the surveyor. The steps of relocating method are described below. First, selecting points of equal elevation on the surface of the cast (30) to define a first locating dot (A), a second locating dot (B), and a third locating dot (C). The first locating dot (A), the second locating dot (B), and the third locating dot (C) form a triangle. Referring to FIG. 7, the tilting adjustment knob (222) is rotated to release the clamping device (221) to adjust the swivel ball (212) and thus cause the angle and direction of the cast clamping table (21) to change. Referring to FIG. 9 and FIG. 10, the angle and direction of the cast (30) is adjusted to allow the first locating dot (A), the second locating dot (B), and the third locating dot (C) to be not only near the first base adjustment screw (O), the second base adjustment screw (P), and the third base adjustment screw (Q) respectively but also consistent in height to complete preliminary calibration. Referring to FIG. 13 and FIG. 14, the height of the second locating dot (B) is measured using the tip of the analyzing rod (151), with the second base adjustment screw (P) as reference, and the first base adjustment screw (O) is adjusted to adjust the height of the first locating dot (A) to allow the first locating dot (A) and the second locating dot (B) to be of equal height, with their height confirmed using the analyzing rod (151). Referring to FIG. 16, the third base adjustment screw (Q) is adjusted to adjust the height of the third locating dot (C) to allow the first locating dot (A) and the third locating dot (C) to be of equal height. Referring to FIG. 13, the first base adjustment screw (O) is adjusted to adjust the height of the first locating dot (A) to allow the first locating dot (A) and the second locating dot (B) to be of equal height. The first locating dot (A), the second locating dot (B), and the third locating dot (C) become equal in height through repeated adjustments such that the cast (30) is positioned at the correct angle and direction to facilitate cooperation between the dentist and the dental technician, further enhancing operation efficiency as well as the precision of partial denture fabrication.

The principles of the dental surveyor and the survey method of the disclosure are described below. The angle and direction of the cast (30) are adjusted using the tilting adjustment knob (222), and the front-back and left-right inclinations of the cast (30) are preliminarily determined, allowing the first locating dot (A), the second locating dot (B), and the third locating dot (C) to be near the first base adjustment screw (O), the second base adjustment screw (P), and the third base adjustment screw (Q) respectively. Therefore, the first base adjustment screw (O), the second base adjustment screw (P), or the third base adjustment screw (Q) can be determined and adjusted such that the height variation of one of the three dots is greater than that of the other two because of the adjustment of a corresponding one of the first locating dot (A), the second locating dot (B), and the third locating dot (C).

Referring to FIG. 7 through FIG. 10, the disclosure provides a relocating method using the dental surveyor to locate the path of insertion and removal of the cast on the surveyor. The relocating method comprises the steps described below. In step I, the angle and position of the cast (30) are adjusted using the tilting adjustment knob (222) to not only allow the first locating dot (A), the second locating dot (B), and the third locating dot (C) on the cast to be near the first base adjustment screw (O), the second base adjustment screw (P), and the third base adjustment screw (Q) respectively, but also allow the first locating dot (A), the second locating dot (B), and the third locating dot (C) to be of nearly the same height.

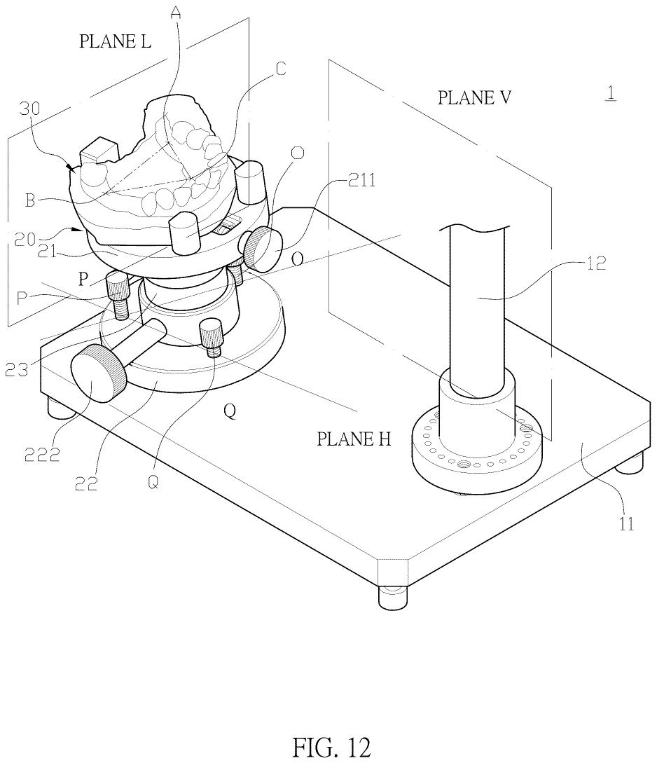

Referring to FIG. 12, according to the principles of projective geometry, the projections of the first base adjustment screw (O), the second base adjustment screw (P), and the third base adjustment screw (Q) onto plane H, plane V, and plane L are referred to as dot O, dot P, and dot Q respectively, and the lines connecting each pair of the three dots O, P, and Q are referred to as line OP, line PQ, and line OQ, respectively.

The first locating dot (A), the second locating dot (B), and the third locating dot (C), which are projected onto plane H, plane V, and plane L, are herein referred to as three dots A, B, and C to facilitate reading and comprehension.

Referring to FIG. 12, according to the principles of projective geometry, dot O is the contact point between the first base adjustment screw (O) and the surveyor platform (11), dot P is the contact point between the second base adjustment screw (P) and the surveyor platform (11), and dot Q is the contact point between the third base adjustment screw (Q) and the surveyor platform (11), allowing plane H, plane V, and plane L in the three-dimensional coordinate system to be the imaginary planes for the surveyor platform (11). Thus, the three dots O, P, and Q must lie on plane H. Plane V is penetrated by line OP and is perpendicular to line OP. Plane Lis penetrated by line PQ and is perpendicular to line PQ. Plane V and plane L are perpendicular to plane H but are not necessarily perpendicular to each other.

Referring to FIG. 13 and FIG. 14, the relocating method using the dental surveyor to locate the path of insertion and removal of the cast on the surveyor further comprises step II, which involves adjusting the first base adjustment screw (O) to adjust the height of the first locating dot (A) and adjusting the second base adjustment screw (P) to adjust the height of the second locating dot (B), so as to allow the first locating dot (A) and the second locating dot (B) to be of equal height.

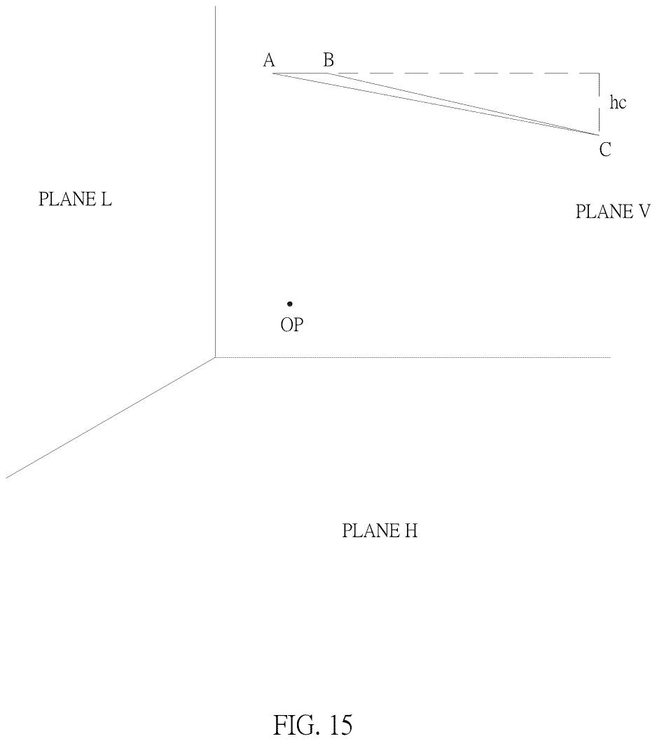

Referring to FIG. 15, according to the principles of projective geometry, regarding the projections of dot A, dot B, and dot C onto plane V, both dot A and dot B are of equal height and are higher than dot C by a height difference hc, line OP coincides to become a dot.

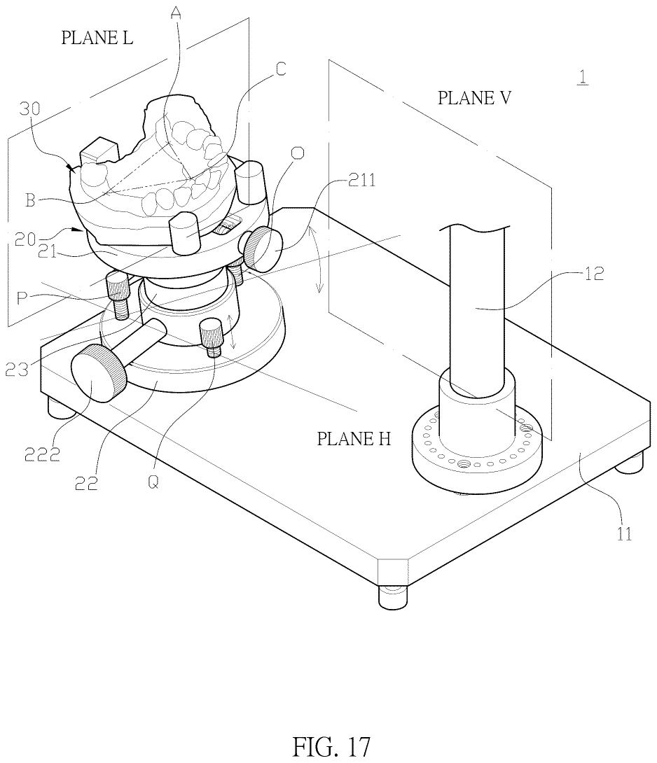

Referring to FIG. 16, the relocating method using the dental surveyor to locate the path of insertion and removal of the cast on the surveyor further comprises step III, which involves adjusting the third base adjustment screw (Q) to adjust the height of the third locating dot (C), so as to allow the first locating dot (A) and the third locating dot (C) to be of equal height. Referring to FIG. 17, the three dots A, B and C rotate about line OP.

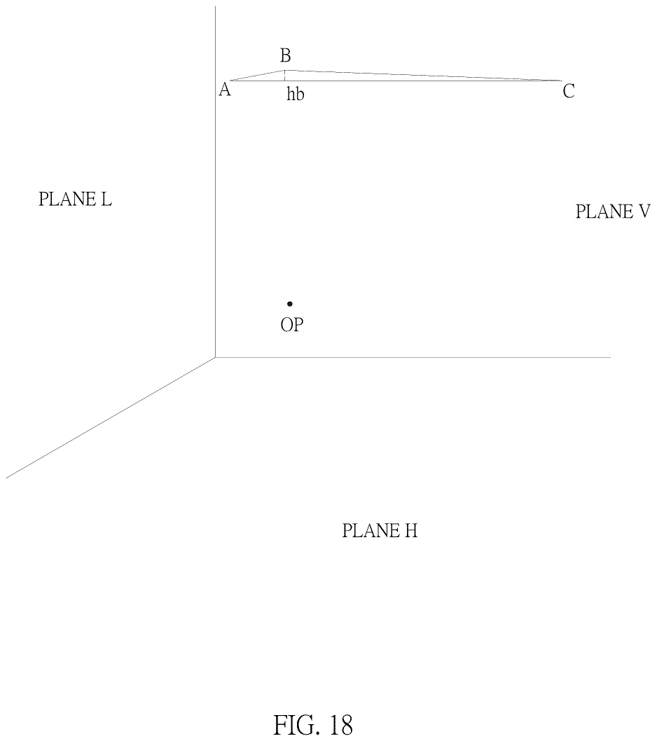

Referring to FIG. 18, according to the principles of projective geometry, regarding the projections of dot A, dot B, and dot C onto plane V, dot A, dot B, and dot C rotate about line OP until dot A and dot C become equal in height to cause a change to the “equal in height” relationship between dot A and dot B in Step II. The three dots have a height difference hb, where hc:hb=AC:AB, and he is much greater than hb, indicating that the height difference between the three dots is decreasing.

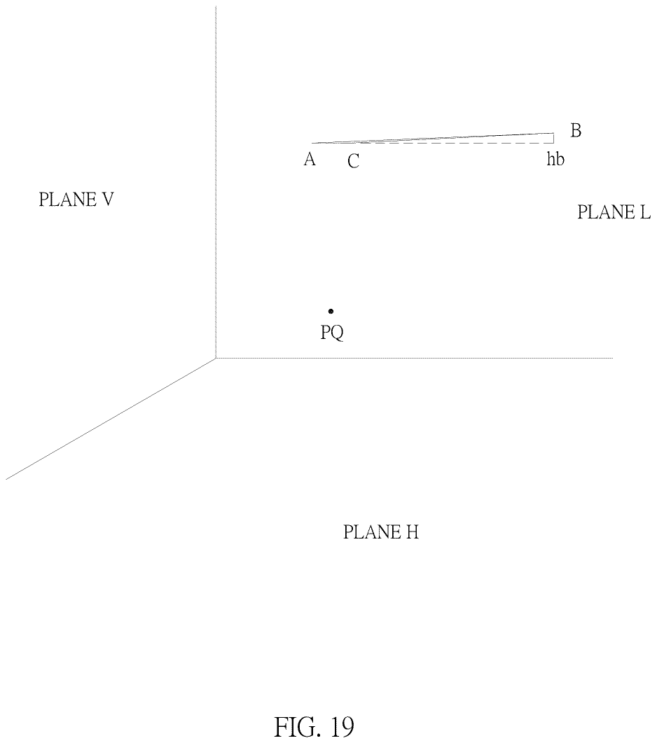

Referring to FIG. 19, according to the principles of projective geometry, regarding the projections of dot A, dot B, and dot C onto plane L, both dot A and dot C are of equal height and are lower than dot B by a height difference hb, line PQ coincides to become a dot.

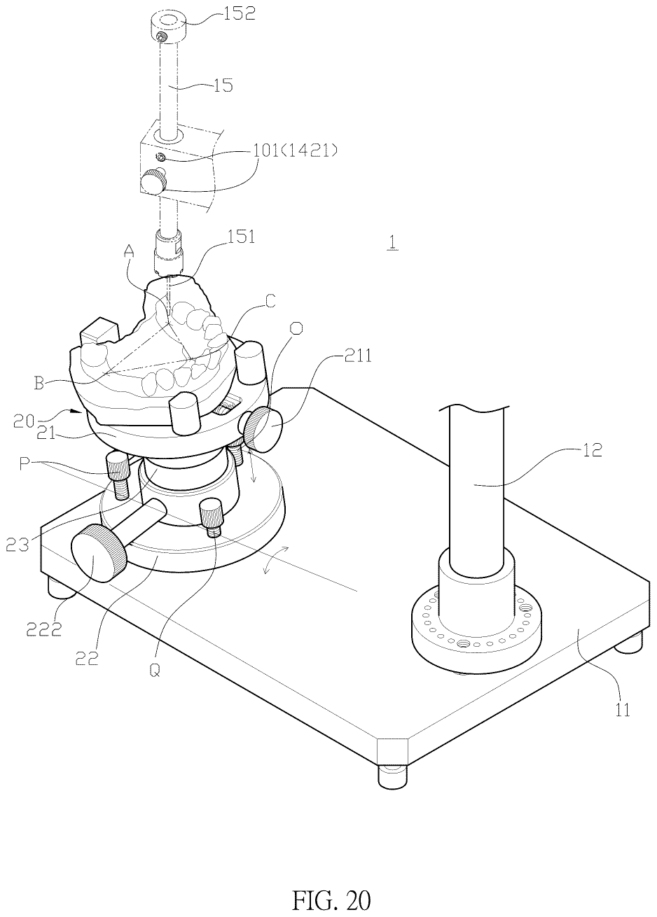

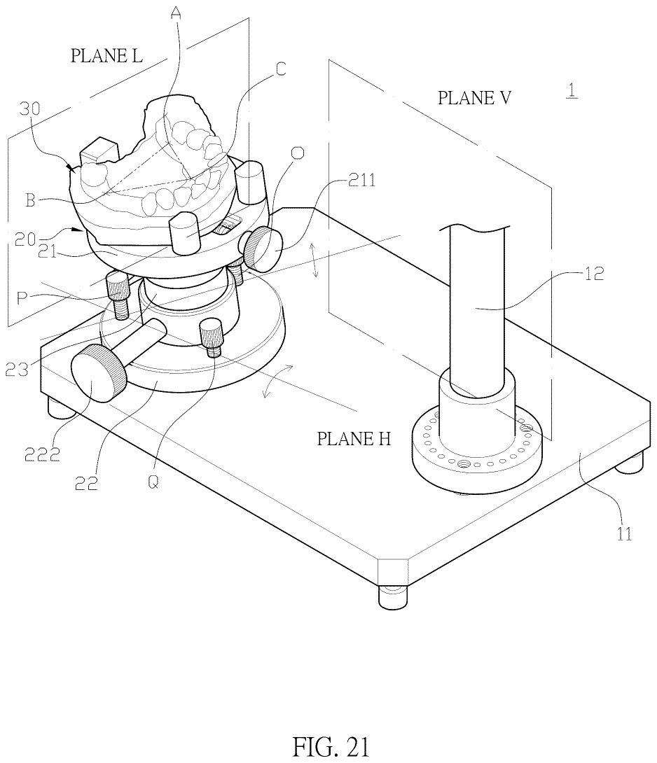

Referring to FIG. 20, the relocating method using the dental surveyor to locate the path of insertion and removal of the cast on the surveyor further comprises step IV, which involves adjusting the first base adjustment screw (O) to adjust the height of the first locating dot (A), so as to allow the first locating dot (A) and the second locating dot (B) to be of equal height. Referring to FIG. 21, the three dots A, B, and C rotate about line PQ.

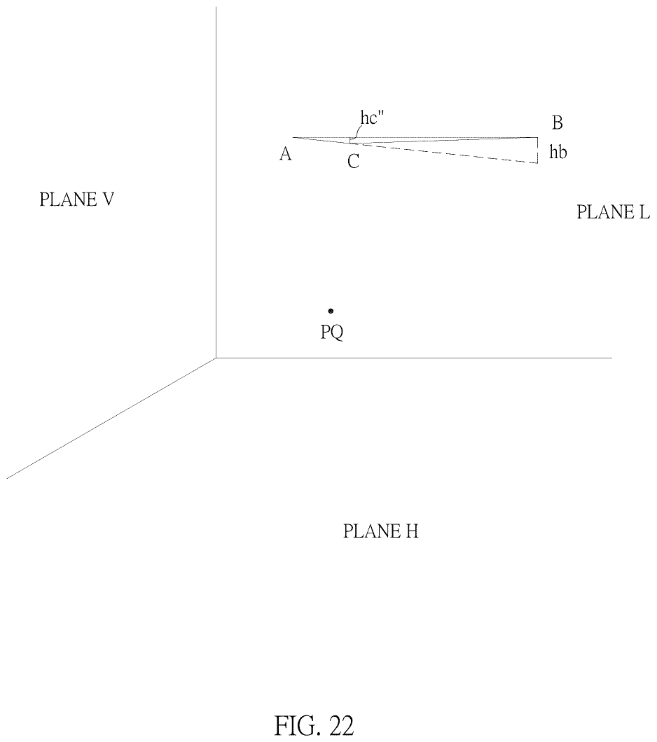

Referring to FIG. 22, according to the principles of projective geometry, regarding the projections of dot A, dot B, and dot C onto plane L, both dot A and dot B are of equal height and are higher than dot C by a height difference hc″, line PQ coincides to become a dot.

The aforesaid principles reveal that the height difference between the three dots decreases from hc to hb and then to hc″ until the height difference dwindles to become indiscernible, so as to achieve tripoding.

Owing to repeated adjustments of the heights of the base adjustment screws, the height difference between the three locating dots decreases gradually until the first locating dot (A), the second locating dot (B), and the third locating dot (C) become equal in height. Therefore, users can adjust the cast (30) until the cast (30) attains the correct angle and direction, so as to complete reproducing the path of insertion and removal of the cast (30) on the dental surveyor (1).

Referring to FIG. 24 and FIG. 25, the analyzing rod (151) is used to survey a tooth portion of the cast (30) to provide reference for determining a path of insertion during partial denture fabrication, and thus enable the fabricated partial denture to be worn at its optimal angle.

In conclusion, the advantages of the dental surveyor and the survey method of the disclosure are described below. First, the path of insertion and removal of the cast (30) is precisely adjusted and determined. Since adjusting any one of the first base adjustment screw (O), the second base adjustment screw (P), and the third base adjustment screw (Q) does not affect the other two, the front-back and left-right inclinations of the cast (30) can be precisely adjusted and determined using the first base adjustment screw (O), the second base adjustment screw (P), or the third base adjustment screw (Q). Second, the angle and direction of the cast (30) can be adjusted using the surveyor table base (22) such that the first locating dot (A), the second locating dot (B), and the third locating dot (C) are not only preliminarily near the first base adjustment screw (O), the second base adjustment screw (P), and the third base adjustment screw (Q) respectively but also nearly equal in height in order for preliminary calibration to be carried out quickly. Third, the height of a portion of the cast (30) can be adjusted using the first base adjustment screw (O), the second base adjustment screw (P), and the third base adjustment screw (Q) in order for tripoding to be carried out quickly, intuitively, easily and precisely. Fourth, parallelism-related errors that might otherwise arise from axial hole tolerance between the first surveying arm (13) and the second surveying arm (14) and between the first surveying arm (13) and the vertical column (12) can be eliminated using thrust bearings, and perpendicularity-related errors that might otherwise arise from axial hole tolerance between the vertical spindle (15) and the vertical spindle bushing (143) can be eliminated using the spring-loaded ball screws (101), so as to cause the vertical column (12), the first surveying arm (13), the second surveying arm (14), and the vertical spindle (15) to rotate pivotally relative to each other and maintain a very high level of parallelism and perpendicularity. Fifth, the vertical column (12), the first surveying arm (13), and the second surveying arm (14) rotate pivotally relative to each other, and the analyzing rod (151) quickly measures the heights of the first locating dot (A), the second locating dot (B), and the third locating dot (C) to carry out the survey method, achieving efficiency enhancement. Sixth, with the survey method of the disclosure, height errors are reduced through iterative approximation performed between the third locating dot (C) and the second locating dot (B) after the first locating dot (A) and the second locating dot (B) have been adjusted to be of equal height; thus, the first locating dot (A), the second locating dot (B), and the third locating dot (C) become equal in height sooner to allow the cast (30) to attain the correct angle and direction to facilitate cooperation between the dentist and the dental technician, further enhancing operation efficiency.

The disclosure is disclosed above by a preferred embodiment, but the preferred embodiment is not restrictive of the scope of implementation of the disclosure. All equivalent changes and modifications made to the preferred embodiment according to the claims of the disclosure shall be deemed falling within the scope of the claims of the disclosure.

What is claimed is:

1. A dental surveyor, comprising:
a surveyor comprising a surveyor platform, a vertical column, a first surveying arm, a second surveying arm, and a vertical spindle, the vertical column being secured to the surveyor platform, the first surveying arm being pivotally connected to the vertical column, the second surveying arm being pivotally connected to the first surveying arm to cause the vertical column, the first surveying arm, and the second surveying arm to rotate pivotally relative to each other, the second surveying arm being fitted with the vertical spindle, the vertical spindle being fitted with an analyzing rod for surveying a cast; and
a surveyor table comprising a cast clamping table and a surveyor table base and being placed on the surveyor platform, with the cast clamping table configured to grip a cast and have a cast holding knob for adjusting grip tightness, with a spherical swivel ball disposed at a bottom of the cast clamping table, with a clamping device disposed centrally on the surveyor table base, fitted with a tilting adjustment knob, and configured to hold the swivel ball, the tilting adjustment knob being rotatable to release the clamping device to adjust the swivel ball and thus cause alteration of an angle and direction of the cast clamping table, with a swivel ball housing disposed at a top of the surveyor table base to restrain the swivel ball, with the surveyor table base fitted with a first base adjustment screw, a second base adjustment screw, and a third base adjustment screw, wherein a height of the cast clamping table, which corresponds to that of the first base adjustment screw, the second base adjustment screw, or the third base adjustment screw, is changed because of advances and retreats of the first base adjustment screw, the second base adjustment screw, or the third base adjustment screw, achieving tripoding adjustment.

2. The dental surveyor of claim 1, wherein the vertical column is secured to the surveyor platform, and a pivot shaft is disposed at a top of the vertical column, with the first surveying arm penetrated by an axial hole and a first hinge hole, allowing a first insertion hole and a second insertion hole to be formed on lateral sides of the axial hole and the first hinge hole respectively, with the pivot shaft penetratingly disposed in the axial hole, with the second surveying arm penetrated by a second hinge hole and a vertical spindle hole, allowing a third insertion hole and three fourth insertion holes to be formed on lateral sides of the second hinge hole and the vertical spindle hole respectively, the vertical spindle hole being fitted with a vertical spindle bushing, the fourth insertion holes being fitted with spring-loaded ball screws to allow the vertical spindle bushing to be secured inside the fourth insertion holes, with a vertical spindle penetratingly disposed in the vertical spindle bushing, the vertical spindle being fitted with an analyzing rod for surveying a cast, with a stop portion fitted to a top of the vertical spindle and configured to abut the vertical spindle bushing to limit a range of motion (ROM) of the vertical spindle, with the spring-loaded ball screws secured to upper and lower ones of the fourth insertion holes respectively and configured to exert uniform pressure on the vertical spindle to eliminate a tolerance of the vertical spindle inside the vertical spindle bushing to enhance precision, with a vertical spindle fastening screw secured to a middle one of the fourth insertion holes, configured to abut the vertical spindle, and configured to be tightened or loosened to adjust and then fix a position of the vertical spindle, with a sliding bushing penetratingly disposed in each of the first hinge hole and the second hinge hole and penetrated by a pivotal connection shaft, with a stopping screw screwed into the second insertion hole to abut the pivotal connection shaft to secure the pivotal connection shaft in place and thus cause the vertical column, the first surveying arm, and the second surveying arm to rotate pivotally relative to each other, the first surveying arm being secured to the first insertion hole and the pivot shaft by a clamping lever to adjust and then fix an angle between the vertical column and the first surveying arm, the second surveying arm being secured to the third insertion hole by another said clamping lever to abut the pivotal connection shaft to adjust and then fix an angle between the first surveying arm and the second surveying arm, wherein tops of the pivot shaft and the pivotal connection shaft are provided with a cover screw for restraining the tops, wherein the first surveying arm and the second surveying arm have washers and bearing portions for enhancing smoothness of pivotal rotation to enable the vertical column, the first surveying arm, and the second surveying arm to rotate pivotally relative to each other interlockingly.

3. The dental surveyor of claim 2, wherein the vertical spindle bushing is made of copper and provided in form of a centrally-bored copper post.

4. The dental surveyor of claim 2, wherein the bearing portions are thrust bearings.

5. The dental surveyor of claim 2, wherein the vertical column is secured to the surveyor platform from bottom to top using screw fasteners; and the first base adjustment screw, the second base adjustment screw, and the third base adjustment screw are evenly and annularly disposed on the surveyor table base.

6. (canceled)

7. A survey method of using the dental surveyor of claim 1 to determine the path of insertion and removal of the cast on the surveyor, the survey method comprising steps of:
adjusting an angle and direction of the cast, by a dentist with the tilting adjustment knob, to preliminarily determine front-back and left-right inclinations of the cast and allow the first base adjustment screw, the second base adjustment screw, and the third base adjustment screw to be near the cast in front-back and left-right directions respectively; and
determining and adjusting the first base adjustment screw, the second base adjustment screw, or the third base adjustment screw to adjust the front-back and left-right inclinations of the cast.

8. A survey method of using the dental surveyor of claim 1 to record and reproduce the path of insertion and removal of the cast on the surveyor, the survey method comprising steps of:
recording, by a dentist, the path of insertion and removal of the cast on the dental surveyor such that the determined direction and inclinations of the surveyed cast define the path of insertion and removal, and three separate points of equal elevation on the surface of the cast are selected according to a tripoding method to define a first locating dot, a second locating dot, and a third locating dot before the dentist sends the cast to a dental technician to proceed with reproduction of the path of insertion and removal of the cast and partial denture fabrication; and
adjusting, by the dental technician and before the partial denture fabrication, a position and angle of the cast on the dental surveyor to allow the first locating dot, the second locating dot, and the third locating dot to be adjusted to attain equal height so as to reproduce the cast's insertion and removal path as determined by the dentist.

9. A relocating method using the dental surveyor of claim 1 to locate the path of insertion and removal of the cast on the surveyor, the relocating method comprising steps of:
selecting points of equal elevation on a surface of the cast to define a first locating dot a second locating dot and a third locating dot which form a triangle, rotating the tilting adjustment knob to release the clamping device to adjust the swivel ball and thus cause an angle and direction of the cast clamping table to change, and adjusting an angle and direction of the cast to allow the first locating dot, the second locating dot, and the third locating dot to be not only near the first base adjustment screw, the second base adjustment screw, and the third base adjustment screw respectively but also consistent in height to complete preliminary calibration; and
measuring the height of the second locating dot using a tip of the analyzing rod, with the second base adjustment screw as a reference, adjusting the first base adjustment screw to adjust the height of the first locating dot to allow the first locating dot and the second locating dot to be of equal height, confirming the height of the first locating dot and the second locating dot using the analyzing rod, adjusting the third base adjustment screw to adjust the height of the third locating dot to allow the first locating dot and the third locating dot to be of equal height, and adjusting the first base adjustment screw to adjust the height of the first locating dot to allow the first locating dot and the second locating dot to be of equal height, such that the first locating dot, the second locating dot, and the third locating dot become equal in height through repeated adjustments, allowing the cast to attain a correct angle and direction.

10. A survey method of using the dental surveyor of claim 2 to determine the path of insertion and removal of the cast on the surveyor, the survey method comprising steps of:
adjusting an angle and direction of the cast, by a dentist with the tilting adjustment knob, to preliminarily determine front-back and left-right inclinations of the cast and allow the first base adjustment screw, the second base adjustment screw, and the third base adjustment screw to be near the cast in front-back and left-right directions respectively; and
determining and adjusting the first base adjustment screw, the second base adjustment screw, or the third base adjustment screw to adjust the front-back and left-right inclinations of the cast.

11. A survey method of using the dental surveyor of claim 3 to determine the path of insertion and removal of the cast on the surveyor, the survey method comprising steps of:
adjusting an angle and direction of the cast, by a dentist with the tilting adjustment knob, to preliminarily determine front-back and left-right inclinations of the cast and allow the first base adjustment screw, the second base adjustment screw, and the third base adjustment screw to be near the cast in front-back and left-right directions respectively; and
determining and adjusting the first base adjustment screw, the second base adjustment screw, or the third base adjustment screw to adjust the front-back and left-right inclinations of the cast.

12. A survey method of using the dental surveyor of claim 4 to determine the path of insertion and removal of the cast on the surveyor, the survey method comprising steps of:
adjusting an angle and direction of the cast, by a dentist with the tilting adjustment knob, to preliminarily determine front-back and left-right inclinations of the cast and allow the first base adjustment screw, the second base adjustment screw, and the third base adjustment screw to be near the cast in front-back and left-right directions respectively; and
determining and adjusting the first base adjustment screw, the second base adjustment screw, or the third base adjustment screw to adjust the front-back and left-right inclinations of the cast.

13. A survey method of using the dental surveyor of claim 5 to determine the path of insertion and removal of the cast on the surveyor, the survey method comprising steps of:
adjusting an angle and direction of the cast, by a dentist with the tilting adjustment knob, to preliminarily determine front-back and left-right inclinations of the cast and allow the first base adjustment screw, the second base adjustment screw, and the third base adjustment screw to be near the cast in front-back and left-right directions respectively; and
determining and adjusting the first base adjustment screw, the second base adjustment screw, or the third base adjustment screw to adjust the front-back and left-right inclinations of the cast.

14. A survey method of using the dental surveyor of claim 2 to record and reproduce the path of insertion and removal of the cast on the surveyor, the survey method comprising steps of:
recording, by a dentist, the path of insertion and removal of the cast on the dental surveyor such that the determined direction and inclinations of the surveyed cast define the path of insertion and removal, and three separate points of equal elevation on the surface of the cast are selected according to a tripoding method to define a first locating dot, a second locating dot, and a third locating dot before the dentist sends the cast to a dental technician to proceed with reproduction of the path of insertion and removal of the cast and partial denture fabrication; and
adjusting, by the dental technician and before the partial denture fabrication, a position and angle of the cast on the dental surveyor to allow the first locating dot, the second locating dot, and the third locating dot to be adjusted to attain equal height so as to reproduce the cast's insertion and removal path as determined by the dentist.

15. A survey method of using the dental surveyor of claim 3 to record and reproduce the path of insertion and removal of the cast on the surveyor, the survey method comprising steps of:
recording, by a dentist, the path of insertion and removal of the cast on the dental surveyor such that the determined direction and inclinations of the surveyed cast define the path of insertion and removal, and three separate points of equal elevation on the surface of the cast are selected according to a tripoding method to define a first locating dot, a second locating dot, and a third locating dot before the dentist sends the cast to a dental technician to proceed with reproduction of the path of insertion and removal of the cast and partial denture fabrication; and
adjusting, by the dental technician and before the partial denture fabrication, a position and angle of the cast on the dental surveyor to allow the first locating dot, the second locating dot, and the third locating dot to be adjusted to attain equal height so as to reproduce the cast's insertion and removal path as determined by the dentist.

16. A survey method of using the dental surveyor of claim 4 to record and reproduce the path of insertion and removal of the cast on the surveyor, the survey method comprising steps of:
recording, by a dentist, the path of insertion and removal of the cast on the dental surveyor such that the determined direction and inclinations of the surveyed cast define the path of insertion and removal, and three separate points of equal elevation on the surface of the cast are selected according to a tripoding method to define a first locating dot, a second locating dot, and a third locating dot before the dentist sends the cast to a dental technician to proceed with reproduction of the path of insertion and removal of the cast and partial denture fabrication; and
adjusting, by the dental technician and before the partial denture fabrication, a position and angle of the cast on the dental surveyor to allow the first locating dot, the second locating dot, and the third locating dot to be adjusted to attain equal height so as to reproduce the cast's insertion and removal path as determined by the dentist.

17. A survey method of using the dental surveyor of claim 5 to record and reproduce the path of insertion and removal of the cast on the surveyor, the survey method comprising steps of:
recording, by a dentist, the path of insertion and removal of the cast on the dental surveyor such that the determined direction and inclinations of the surveyed cast define the path of insertion and removal, and three separate points of equal elevation on the surface of the cast are selected according to a tripoding method to define a first locating dot, a second locating dot, and a third locating dot before the dentist sends the cast to a dental technician to proceed with reproduction of the path of insertion and removal of the cast and partial denture fabrication; and
adjusting, by the dental technician and before the partial denture fabrication, a position and angle of the cast on the dental surveyor to allow the first locating dot, the second locating dot, and the third locating dot to be adjusted to attain equal height so as to reproduce the cast's insertion and removal path as determined by the dentist.

18. A relocating method using the dental surveyor of claim 2 to locate the path of insertion and removal of the cast on the surveyor, the relocating method comprising steps of:
selecting points of equal elevation on a surface of the cast to define a first locating dot a second locating dot and a third locating dot which form a triangle, rotating the tilting adjustment knob to release the clamping device to adjust the swivel ball and thus cause an angle and direction of the cast clamping table to change, and adjusting an angle and direction of the cast to allow the first locating dot, the second locating dot, and the third locating dot to be not only near the first base adjustment screw, the second base adjustment screw, and the third base adjustment screw respectively but also consistent in height to complete preliminary calibration; and
measuring the height of the second locating dot using a tip of the analyzing rod, with the second base adjustment screw as a reference, adjusting the first base adjustment screw to adjust the height of the first locating dot to allow the first locating dot and the second locating dot to be of equal height, confirming the height of the first locating dot and the second locating dot using the analyzing rod, adjusting the third base adjustment screw to adjust the height of the third locating dot to allow the first locating dot and the third locating dot to be of equal height, and adjusting the first base adjustment screw to adjust the height of the first locating dot to allow the first locating dot and the second locating dot to be of equal height, such that the first locating dot, the second locating dot, and the third locating dot become equal in height through repeated adjustments, allowing the cast to attain a correct angle and direction.

19. A relocating method using the dental surveyor of claim 3 to locate the path of insertion and removal of the cast on the surveyor, the relocating method comprising steps of:
selecting points of equal elevation on a surface of the cast to define a first locating dot a second locating dot and a third locating dot which form a triangle, rotating the tilting adjustment knob to release the clamping device to adjust the swivel ball and thus cause an angle and direction of the cast clamping table to change, and adjusting an angle and direction of the cast to allow the first locating dot, the second locating dot, and the third locating dot to be not only near the first base adjustment screw, the second base adjustment screw, and the third base adjustment screw respectively but also consistent in height to complete preliminary calibration; and
measuring the height of the second locating dot using a tip of the analyzing rod, with the second base adjustment screw as a reference, adjusting the first base adjustment screw to adjust the height of the first locating dot to allow the first locating dot and the second locating dot to be of equal height, confirming the height of the first locating dot and the second locating dot using the analyzing rod, adjusting the third base adjustment screw to adjust the height of the third locating dot to allow the first locating dot and the third locating dot to be of equal height, and adjusting the first base adjustment screw to adjust the height of the first locating dot to allow the first locating dot and the second locating dot to be of equal height, such that the first locating dot, the second locating dot, and the third locating dot become equal in height through repeated adjustments, allowing the cast to attain a correct angle and direction.

20. A relocating method using the dental surveyor of claim 4 to locate the path of insertion and removal of the cast on the surveyor, the relocating method comprising steps of:
selecting points of equal elevation on a surface of the cast to define a first locating dot a second locating dot and a third locating dot which form a triangle, rotating the tilting adjustment knob to release the clamping device to adjust the swivel ball and thus cause an angle and direction of the cast clamping table to change, and adjusting an angle and direction of the cast to allow the first locating dot, the second locating dot, and the third locating dot to be not only near the first base adjustment screw, the second base adjustment screw, and the third base adjustment screw respectively but also consistent in height to complete preliminary calibration; and
measuring the height of the second locating dot using a tip of the analyzing rod, with the second base adjustment screw as a reference, adjusting the first base adjustment screw to adjust the height of the first locating dot to allow the first locating dot and the second locating dot to be of equal height, confirming the height of the first locating dot and the second locating dot using the analyzing rod, adjusting the third base adjustment screw to adjust the height of the third locating dot to allow the first locating dot and the third locating dot to be of equal height, and adjusting the first base adjustment screw to adjust the height of the first locating dot to allow the first locating dot and the second locating dot to be of equal height, such that the first locating dot, the second locating dot, and the third locating dot become equal in height through repeated adjustments, allowing the cast to attain a correct angle and direction.

21. A relocating method using the dental surveyor of claim 5 to locate the path of insertion and removal of the cast on the surveyor, the relocating method comprising steps of:
selecting points of equal elevation on a surface of the cast to define a first locating dot a second locating dot and a third locating dot which form a triangle, rotating the tilting adjustment knob to release the clamping device to adjust the swivel ball and thus cause an angle and direction of the cast clamping table to change, and adjusting an angle and direction of the cast to allow the first locating dot, the second locating dot, and the third locating dot to be not only near the first base adjustment screw, the second base adjustment screw, and the third base adjustment screw respectively but also consistent in height to complete preliminary calibration; and
measuring the height of the second locating dot using a tip of the analyzing rod, with the second base adjustment screw as a reference, adjusting the first base adjustment screw to adjust the height of the first locating dot to allow the first locating dot and the second locating dot to be of equal height, confirming the height of the first locating dot and the second locating dot using the analyzing rod, adjusting the third base adjustment screw to adjust the height of the third locating dot to allow the first locating dot and the third locating dot to be of equal height, and adjusting the first base adjustment screw to adjust the height of the first locating dot to allow the first locating dot and the second locating dot to be of equal height, such that the first locating dot, the second locating dot, and the third locating dot become equal in height through repeated adjustments, allowing the cast to attain a correct angle and direction.
